(19) United States
(12) Patent Application Publication
(10) Pub. No.: US 2022/0381088 A1
(43) Pub. Date: Dec. 1, 2022

(54) Ladder with Adjustable Lateral Supports

(71) Applicant: Justin Ostroff, Indian Harbour Besch, FL (US)

(72) Inventor: Justin Ostroff, Indian Harbour Beach, FL (US)

(21) Appl. No.: 17/303,414

(22) Filed: May 28, 2021

(51) Int. Cl. E06C 7/42; E06C 1/20

(52) U.S. Cl. CPC E06C 7/423; E06C 1/20

(57) ABSTRACT

A ladder stabilization apparatus and ladder comprising the same, the apparatus including a translatable securing member configured to translate along a translation axis and first and second translatable legs. Translation of the translatable securing member along the translation axis causes rotation of the first translatable leg about a first rotational axis and rotation of the second translatable leg about a second rotational axis.

### FIELD OF THE INVENTION

The present invention relates to systems for improving lateral stability of ladders.

### BACKGROUND OF THE INVENTION

Ladders, particularly ladders that are intended to be temporarily positioned at a location and subsequently removed, are susceptible to tipping over. Primary causes for this include lateral forces, such forces commonly occurring when a user leans to their left or right on a ladder, reaching to the side. Ladders already provide a degree of lateral stability by utilizing two legs that are spaced apart laterally. However, the legs of the ladder can only be positioned laterally apart from one another to a limited degree, as the wider the legs are positioned, the greater the material cost to provide steps that are positioned between the legs, as well as an increase in the cost and weight of the ladder. Moreover, a wider ladder requires additional space when being stored, increasing the burden of storage when not using the ladder. Furthermore, as the legs are positioned further apart, it becomes more difficult to place the ladder stably on ground that has a change in elevation, with greater increases in distance between legs potentially increasing the angle at which the ladder will be positioned when positioned on such a surface. Accordingly, there is a need in the art for a ladder that is capable of temporarily increasing its lateral stability without substantially increasing the ladder's occupied space when not in use, and also having the flexibility to increase lateral stability on uneven terrain.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a ladder comprising a plurality of leg, a plurality of steps connected at each end to the plurality of legs, a translatable securing member configured to translate along a translation axis and be removably secured at a position along the translation axis relative to a first leg of the plurality of legs, a first translatable leg rotatably attached at a first end thereof to the translatable securing member and configured to rotate about a first rotation axis, and a second translatable leg rotatably attached at a first end thereof to the first leg and configured to rotate about a second rotational axis and rotatably attached at a second end thereof to a second end of the first translatable leg and configured to rotate about a third rotational axis. Translation of the translatable securing member along the translation axis causes rotation of the first translatable leg about the first rotational axis and rotation of the second translatable leg about the second rotational axis.

In some embodiments, the ladder may further comprise a retaining structure attached to the first leg and configured to retain the translatable securing member adjacent to the first leg. In further embodiments, the retaining structure may comprise a pair of sidewalls and a pair of upper walls, defining a gap there between. The translatable securing member may comprise a securing control device configured to extend through the gap of the retaining structure. In further embodiments, the sidewalls and upper walls of the retaining structure may cooperate to define a bounded region and the first and second translatable legs may be configured to be positioned within the bounded region when the translatable securing member is at an uppermost position.

In some embodiments the retaining structure may be integrally formed with the first leg. In some embodiments, the second translatable leg may be rotatably attached to the sidewalls. In some embodiments, the translatable securing member may comprise a securing control device configured to interface with an outer surface of the first leg and, when so interfaced, displace the translate the translatable securing member away from the first leg and interface with the upper walls of the retaining structure. Furthermore, the translatable securing member may be secured in place and prevented from translating along the translation axis via the interfacing of the securing control device and the first leg and the interfacing of the translatable securing member and the upper walls. The securing control device may be configured to de-interface with the outer surface of the first leg, thereby, permitting the translatable securing member to translate along the translation axis. In further embodiments, the securing control device may comprise a threaded member and a handle and the translatable securing member may comprise a body member comprising a threaded hole, the threaded hole configured to cooperate with the threads of the threaded member.

In some embodiments, the ladder may further comprise a foot member attached to a lower surface of the second translatable leg. In further embodiments, the second translatable leg and the foot member may be configured such that a lower surface of the foot member is coplanar with a lower surface of the first leg when the translatable securing member is positioned at a lowermost position.

In some embodiments, the translatable securing member and the first translatable leg may be connected by a hinge joint. In some embodiments, the ladder may further comprise a translatable leg connection member. Each of the first and second translatable legs may be rotatably connected to the translatable leg connection member.

In some embodiments, the translatable securing member may be configured to be removably secured at any position along the translation axis relative to the first leg.

Another embodiment of the present invention is directed to a ladder stabilization apparatus comprising a translatable securing member comprising a securing control device, the translatable securing member being configured to translate along a translation axis and be removably secured at a position along the translation axis relative to a ladder leg by operation of the securing control device, a first translatable leg rotatably attached at a first end thereof to the translatable securing member and configured to rotate about a first rotation axis, a second translatable leg rotatably attached at a first end thereof to the first leg and configured to rotate about a second rotational axis and rotatably attached at a second end thereof to a second end of the first translatable end and configured to rotate about a third rotational axis, and a retaining structure attached to the first leg and configured to retain the translatable securing member adjacent to the first leg. The retaining structure may comprise a lower wall configured to be attached to a ladder leg, a pair of sidewalls attached to and extending away from the lower wall, and a pair of upper walls, defining a gap there between. The securing control device may extend through the gap of the retaining structure. Translation of the translatable securing member along the translation axis causes rotation of the first translatable leg about the first rotational axis and rotation of the second translatable leg about the second rotational axis.

### BRIEF DESCRIPTION OF THE DRAWINGS

Some embodiments of the present invention are illustrated as an example and are not limited by the figures of the accompanying drawings, in which like references may indicate similar elements.

FIG. 1 is an elevation view of a ladder comprising adjustable lateral stabilization assemblies according to an embodiment of the invention.

FIG. 2 is a partial view of the ladder of FIG. 1 with a translatable securing member at a maximally proximal position.

FIG. 3 is a partial view of the ladder of FIGS. 1-2 with the translatable securing member at a location such that feet members thereof are coplanar with other ladder feet.

FIG. 4 is a partial view of the ladder of FIGS. 1-3 showing the rotatable connection between the translatable securing member and a first translatable leg.

FIG. 5 is a partial view of the ladder of FIGS. 1-4 showing the rotatable connection between a second translatable leg and sidewalls of the stabilizing apparatus.

FIG. 6 is a side view of a securing control device according to an embodiment of the invention.

FIG. 7 is a top view of a translatable securing member with the securing control device being removed.

FIG. 8 is a bottom view of the translatable securing member of FIG. 7.

FIG. 9 is a front view of a ladder according to an embodiment of the invention showing the translatable securing members are various locations.

FIG. 10 is a partial view of the rotatable connection between the first and second translatable legs according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides an apparatus for providing adjustable lateral support to a ladder. The apparatus may be attached to a ladder or integrally formed with the ladder. The invention may provide lateral support to ladders of any type, particularly ladders that are not fixedly attached to an external structure and are susceptible to falling.

Referring now to FIGS. 1-10, a ladder 100 according to an embodiment of the invention is presented. In the present embodiment, the ladder 100 is a step ladder, but all ladders as are known in the art are contemplated and included within the scope of the invention, including, but not limited to, extension ladders, multi-position ladders, platform ladders, and the like. In the present embodiment, the ladder 100 comprises a plurality of legs, specifically, a first pair of legs 102 with a plurality of steps 104 attached there between and a second pair of legs 106 with a plurality of supports 108 attached there between. The ladder 100 further comprises a platform 110 to which each of the first and second pairs of legs 102, 106 are pivotally attached.

The ladder 100 further comprises first and second lateral stabilization apparatuses 120′, 120″. Each lateral stabilization apparatus 120′, 120″ may be attached to a leg of the ladder 100. In the present embodiment, the lateral stabilization apparatuses 120′, 120″ are attached to respective legs 102′, 102″ of the first pair of legs 102. The attachment between the lateral stabilization apparatuses 120′, 120″ and the legs 102′, 102″ may be such that at least one element of the lateral stabilization apparatuses 120′, 120″ is fixedly attached to the leg 102′, 102″ such that relative motion therebetween is prevented. In some embodiments, a portion or element of the lateral stabilization apparatus 120′, 120″ may be integrally formed and/or formed as a single contiguous structure with its associated leg 102′, 102″. While the present embodiment comprises a ladder 100 comprising two lateral stabilization apparatuses 120′, 120″ it is contemplated and included within the scope of the invention that a ladder may comprise any number of such apparatuses, as few as one and with no upper limit. Furthermore, while the elements of lateral stabilization apparatus 120′ will be discussed in detail, the lateral stabilization apparatus 120″ attached to the leg 102″ may comprise the same elements, positioned for operation on the opposite side of the ladder 100 but identical in functionality.

Each lateral stabilization apparatus 120′, 120″ may comprise a translatable securing member 130, a first translatable leg 140, and a second translatable leg 150. The first translatable leg 140 may be rotatably connected at a first end 142 thereof to an end 132 of the translatable securing member 130 and at a second end 144 thereof to a first end 152 of the second translatable leg 150. The rotatable connection between the translatable securing member 130 and the first translatable leg 140 may be accomplished by any structure as is known in the art, including, but not limited to, bearings, including hinges, such as barrel hinges. The rotatable connection may define a first rotation axis

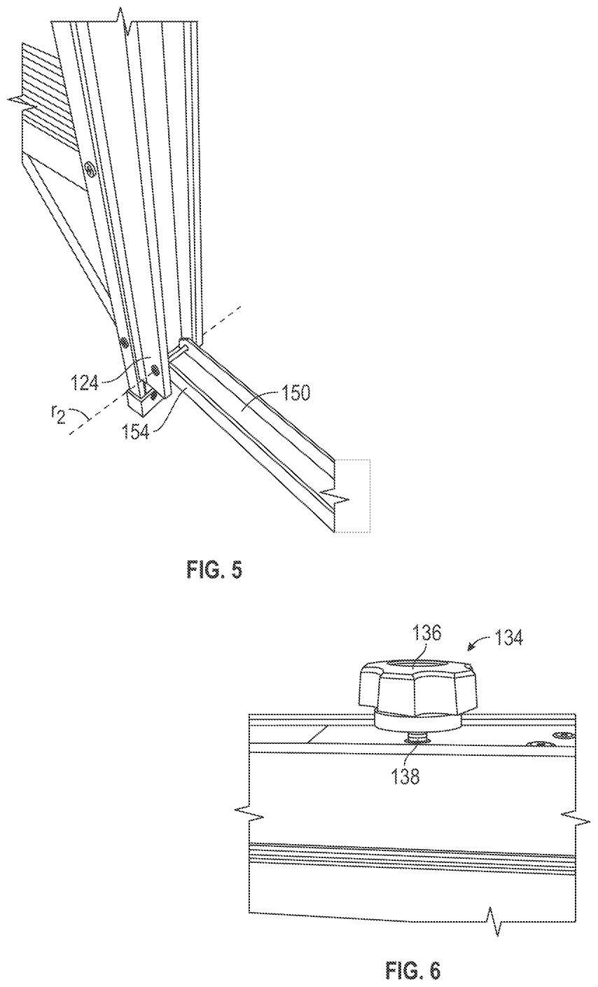

The lateral stabilization apparatuses 120′, 120″ may further comprise a retaining structure comprising a lower wall 122, sidewalls 124, and upper walls 126. In the present embodiment, the lower wall 122 is fixedly attached to an outer face of the leg 102′, thereby attaching the lateral stabilization apparatus 120′ to the leg 102′. Any means or method of attachment as is known in the art is contemplated and included within the scope of the invention, including, but not limited to, fasteners, such as screws, bolts, and rivets, welding, adhesives, and the like. Some embodiments may omit the lower wall 122, particularly those where the lateral stabilization apparatuses 120′, 120″ are integrally formed with the legs 102′, 102″. The sidewalls 124 extend generally away from the lower wall 122/the leg 102′, and the upper walls 126 extend generally towards each other/inward from a upper end of the sidewalls 124, defining a gap 128 between the upper walls 126. Where the lateral stabilization apparatuses 120′, 120″ are integrally formed with the legs 102′, 102″, the sidewalls 124 may extend outward from the legs 102′, 102″. As shown in FIG. 5, a second end 154 of the second translatable leg 150 may be rotatably coupled to the sidewalls 124 at a lower end of the sidewalls 124 by any means as known in the art and/or described above. In some embodiments, the second translatable leg 150 may be connected at its second end 154 to one of the lower wall 122 and/or the leg 102′.

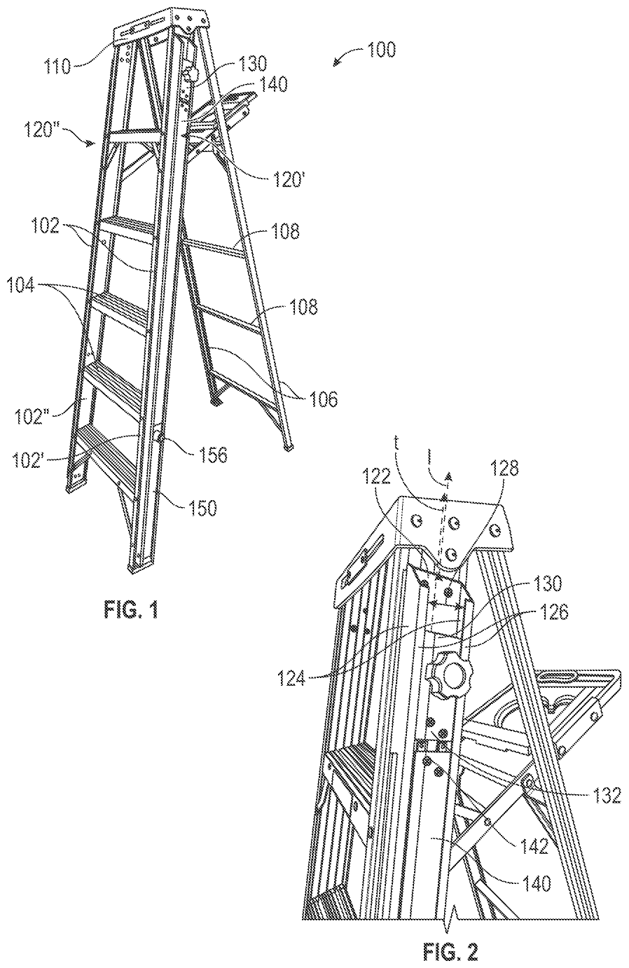

The translatable securing member 130 may be configured to translate along a translation axis t. Specifically, a user may translate the translatable securing member 130 along the translation axis t. The translation axis t may be generally parallel to a longitudinal axis/of the leg 102′, 102″ to which the lateral stabilization apparatus 120′, 120″ is attached to/integrally formed with. FIG. 2 depicts the lateral stabilization apparatus 120′ at a first position. In the first position, the translatable securing member 130 is at a maximally proximal location to which the translatable securing member 130 may translate. The translatable securing member 30 may be constrained from translating further proximally by its connection to the first translatable leg 140, which is in turn connected to the second translatable leg 150, the second end 154 thereof being prevented from translating proximally due to its connection to the sidewalls 124. When in the first position, each of the first translatable leg 140 and the second translatable leg 150 may be positioned within an area bounded by the sidewalls 124 and the upper walls 126, defining a bounded region. Accordingly, the first and second translatable legs may have a width that is less than the size of the gap 128, such that they may be positioned within and moved out of the bounded area.

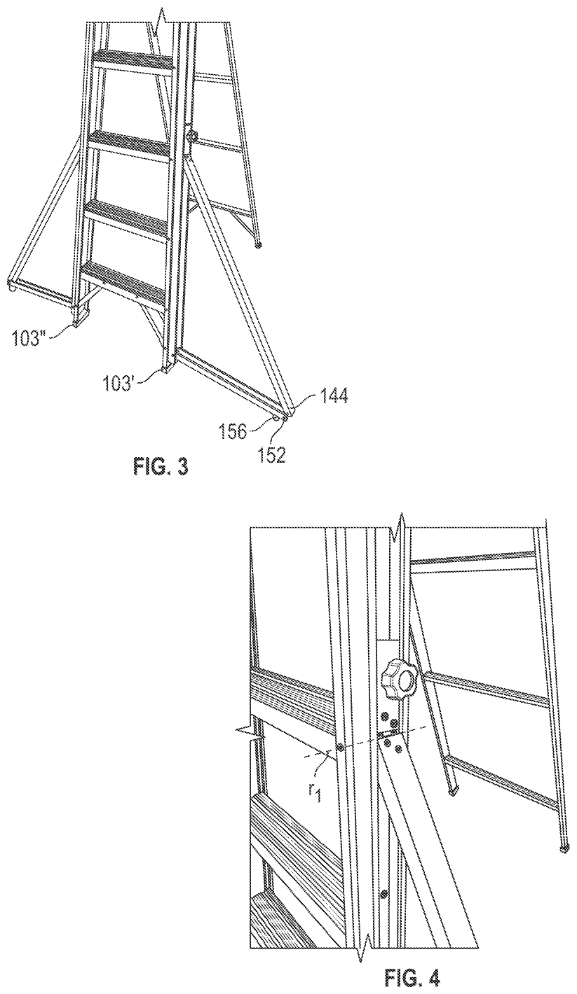

As shown in FIG. 3, the translatable securing member 130 may be translated by a user distally along translation axis t to a point distal the location shown in FIG. 2. As the translatable securing member 130 translates distally, the first end 142 of the first translatable leg 140 may rotate about a first rotational axis, defined as the rotational connection between the translatable securing member 130 and the first translatable leg 140, causing the second end 144 of the first translatable leg 140 to move outward, away from the leg 102′. This may in turn cause first end 152 of the second translatable leg 150 to also be moved outward and away from the leg 102′, thereby causing the second end 154 of the second translatable leg 150 to rotate about a second rotational axis r₂, being the rotatable connection between the second translatable leg 150 and the sidewall 124. The rotatable connection may be accomplished by any means, method, or structure as is known in the art, including, but not limited to, hinges, pins, and the like.

Once a user has translated the translatable securing member 130 to a desired location, the translatable securing member 130 may be locked at that location by operation of a securing control device 134. The securing control device 134 may be configured to give the user the ability to secure the translatable securing member 130 in its present location, preventing its translation along the translation axis t. By preventing such translation, the first and second translatable legs 140, 150 may be prevented from moving.

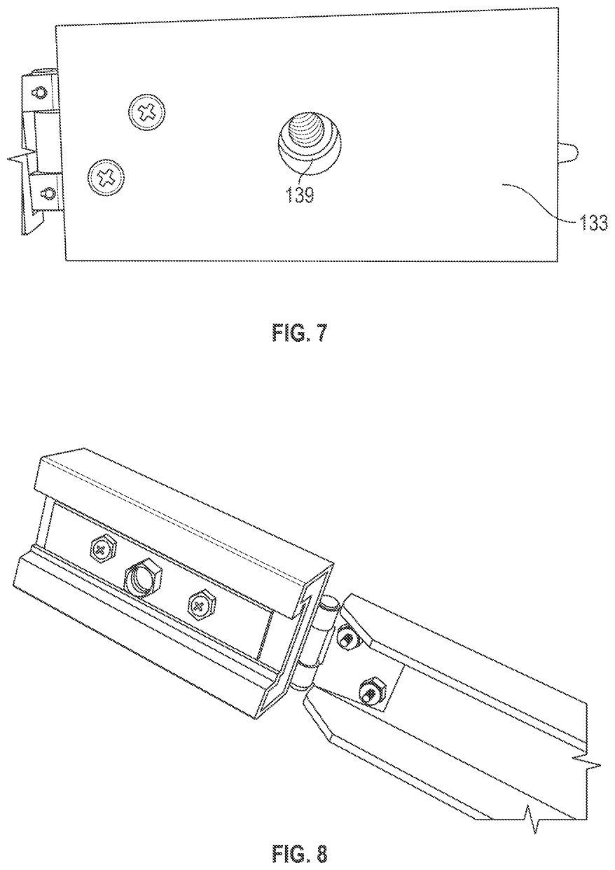

As shown in FIG. 3, an interface between a structure of the second rotatable leg 150 and a surface, such as the ground, floor, or wall, may prevent the ladder 100 from tipping over in the direction of the interface point, thereby providing enhanced lateral stability to the ladder 100. The securing control device 134 may be any device that is operable to prevent the relative movement of the translatable securing member to the leg 102′ and/or translate along the translation axis t. In the present embodiment, and as shown in FIGS. 6 and 7. the securing control device 134 comprises a handle 136 and a threaded member 138, and the translatable securing member 130 may comprise a body member 133 comprising a threaded aperture 139 formed therein. The threaded aperture 139 may engage with the threads of the threaded member 138 such that the user may turn the handle 136 and screw the securing control device 134 such that the threaded member 138 extends through the threaded aperture 139 and interfaces with one of the lower wall 122 and the leg 102′. Such interfacing may cause the translatable securing member 130 to be pushed away from the lower wall 122/leg 102′ and an upper surface thereof may interface with a lower surface of the upper walls 126. The friction between the lower wall 122/leg 102′ and the threaded member 138 as wells as between the translatable securing member 130 and the upper wall 136 may prevent the translation of the translatable securing member 130 along the translation axis t, thereby securing the translatable securing member 130 in place as described above. The translatable securing member 130 may be secured in this manner at any point along the translation axis t relative to the leg 102′. The user may then unscrew the securing control device 134 to de-interface with the lower wall 122 or the leg 102′, thereby releasing the translatable securing member 130 and permitting it to once against translate along the translation axis t.

In some embodiments, the second translatable leg 150 may comprise a feature configured to facilitate interfacing between the second rotatable leg and an external surface. In the present embodiment, the second translatable leg 150 comprises a foot member 156. The foot member 156 may be attached to a lower surface of the second translatable leg 150 and extend away therefrom, such that it may be the sole point of contact between the second translatable leg 150 and the external surface. The foot member 156 may include characteristics that may facilitate its interfacing with the external surface and improve the lateral stability of the ladder 100. In some embodiments, the foot member 156 may be formed from a durable rubber material, such that may have static friction with the external surface and withstand loading without causing physical degradation thereof, as well as avoiding damage to the external surface. The foot member 156 may be attached to the second translatable leg 150 by any means or method as is known in the art, including, but not limited, fasteners, such as screws and nails, adhesives, glues, welding, interference fits, and the like.

In some embodiments, the foot member 156 may be configured so as to extend a distance away from the second translatable leg 150 such that, when the translatable securing member 130 is at a certain location along translation axis t, the foot member 156 is coplanar with a plane defined by feet 103′, 103″ of the legs 102′, 102″ or any other lower surface of the ladder 100.

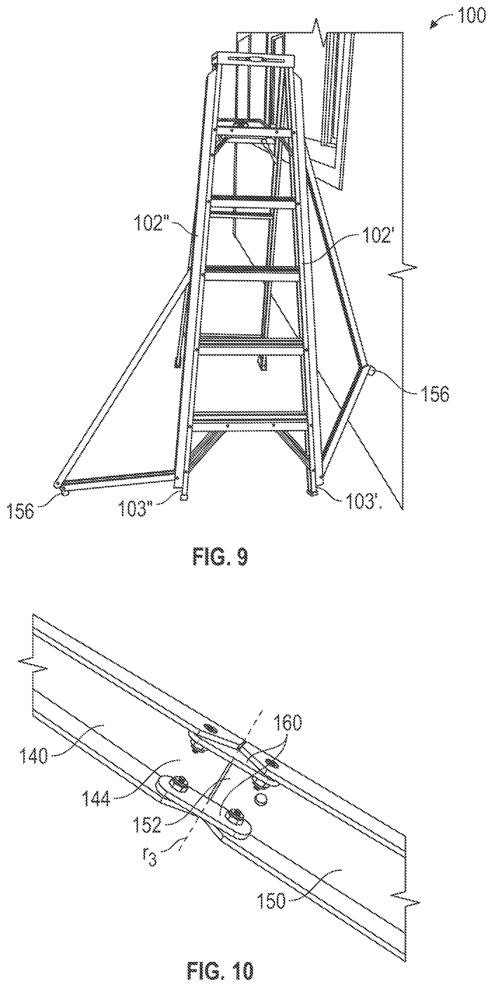

As described above, the translatable securing member 130 may be secured in a position anywhere along translation axis t. As shown in FIG. 9, such locations can include those that result in the foot member 156 being in a position above the foot 103′ of the leg 102′, enabling the foot member 156 to interface with a vertical surface in the environment, and those that result in the foot member 156 being in a position below the foot 103″ of the leg 102″, enabling the foot member 156 to interface with a surface below the feet 103′, 103″ of the ladder 100. This ability to position the translatable securing member 130 at various positions along the translatable axis t so as to position the foot member 156 at a variety of locations may permit the ladder 100 to improve its lateral stability in a wide variety of circumstances, including where the ground is not level and/or where an external structure or surface prevents the full extension of the first/second translatable legs 140, 150 to position the foot member 156 on a plane with the feet 103′, 103″ of the ladder 100.

The first and second translatable legs 140, 150 may be coupled together such that as the translatable securing member 130 translates along translation axis t, the rotation of the first rotatable leg 140 about the first rotation axis r₁ causes a second end 144 thereof to translate away from the first leg 102′ and cause a first end 152 of the second rotatable leg 150 to also be rotated away from the leg 102′ thereby causing the second end 154 thereof to rotate about rotational axis r₂. In order to facilitate such rotational and translation, the stabilization apparatus 120′ may further comprise one or more translatable leg connection members 160, as shown in FIG. 10. The translatable leg connection members 160 may be configured to enable the rotatable attachment of the first and second legs 140, 150 to accommodate the various angles and lateral translations that each leg may experience, such that the legs 140, 150 may rotate about a third rotational axis r₃.

The translatable leg connection members 160 may be bars and/or plates of material to which each translatable leg 140, 150 is rotatably connect at respective ends. In the present embodiment, each of the first and second translatable legs 140, 150 may be substantially C-shaped, defining a hollow interior. The translatable leg connection members 160 may be attached to a surface of the hollow interiors of the first and second translatable legs 140, 150. It is contemplated and included within the scope of the invention that the translatable leg connection members 160 may be connected to any part of the first and second translatable legs 140, 150 that facilitates their above-described translation and rotation. Moreover, such connection may prevent each translatable leg 140, 150 from interfering with the rotation/translation of the other. In some embodiments, the second end 144 of the first translatable leg 140 and the first end 152 of the second translatable leg 150 may be at least partially mitered to prevent such interference.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A ladder comprising:
a plurality of legs;
a plurality of steps connected at each end to the plurality of legs;
a translatable securing member configured to translate along a translation axis and be removably secured at a position along the translation axis relative to a first leg of the plurality of legs;
a first translatable leg rotatably attached at a first end thereof to the translatable securing member and configured to rotate about a first rotation axis; and
a second translatable leg rotatably attached at a first end thereof to the first leg and configured to rotate about a second rotational axis and rotatably attached at a second end thereof to a second end of the first translatable leg and configured to rotate about a third rotational axis;
wherein translation of the translatable securing member along the translation axis causes rotation of the first translatable leg about the first rotational axis and rotation of the second translatable leg about the second rotational axis.

2. The ladder of claim 1 further comprising a retaining structure attached to the first leg and configured to retain the translatable securing member adjacent to the first leg.

3. The ladder of claim 2 wherein:
the retaining structure comprises:
a pair of sidewalls; and
a pair of upper walls, defining a gap there between; and
the translatable securing member comprises a securing control device configured to extend through the gap of the retaining structure.

4. The ladder of claim 3 wherein:
the sidewalls and upper walls of the retaining structure cooperate to define a bounded region; and
the first and second translatable legs are configured to be positioned within the bounded region when the translatable securing member is at an uppermost position.

5. The ladder of claim 3 wherein the retaining structure is integrally formed with the first leg.

6. The ladder of claim 3 wherein the second translatable leg is rotatably attached to the sidewalls.

7. The ladder of claim 3 wherein:
the translatable securing member comprises a securing control device configured to interface with an outer surface of the first leg and, when so interfaced, displace the translate the translatable securing member away from the first leg and interface with the upper walls of the retaining structure;
the translatable securing member is secured in place and prevented from translating along the translation axis via the interfacing of the securing control device and the first leg and the interfacing of the translatable securing member and the upper walls; and
the securing control device is configured to de-interface with the outer surface of the first leg, thereby, permitting the translatable securing member to translate along the translation axis.

8. The ladder of claim 7 wherein:
the securing control device comprises a threaded member and a handle; and
the translatable securing member comprises a body member comprising a threaded hole, the threaded hole configured to cooperate with the threads of the threaded member.

9. The ladder of claim 1 further comprising a foot member attached to a lower surface of the second translatable leg.

10. The ladder of claim 9 wherein the second translatable leg and the foot member are configured such that a lower surface of the foot member is coplanar with a lower surface of the first leg when the translatable securing member is positioned at a lowermost position.

11. The ladder of claim 1 wherein the translatable securing member and the first translatable leg are connected by a hinge joint.

12. The ladder of claim 1 further comprising a translatable leg connection member; wherein each of the first and second translatable legs are rotatably connected to the translatable leg connection member.

13. The ladder of claim 1 wherein the translatable securing member is configured to be removably secured at any position along the translation axis relative to the first leg.

14. A ladder stabilization apparatus comprising:
a translatable securing member comprising a securing control device, the translatable securing member being configured to translate along a translation axis and be removably secured at a position along the translation axis relative to a ladder leg by operation of the securing control device;
a first translatable leg rotatably attached at a first end thereof to the translatable securing member and configured to rotate about a first rotation axis;
a second translatable leg rotatably attached at a first end thereof to the first leg and configured to rotate about a second rotational axis and rotatably attached at a second end thereof to a second end of the first translatable end and configured to rotate about a third rotational axis; and
a retaining structure attached to the first leg and configured to retain the translatable securing member adjacent to the first leg, the retaining structure comprising:
a lower wall configured to be attached to a ladder leg;
a pair of sidewalls attached to and extending away from the lower wall; and
a pair of upper walls, defining a gap there between; and
wherein the securing control device extends through the gap of the retaining structure; and
wherein translation of the translatable securing member along the translation axis causes rotation of the first translatable leg about the first rotational axis and rotation of the second translatable leg about the second rotational axis.

15. The ladder stabilization apparatus of claim 14 wherein:
the sidewalls and upper walls of the retaining structure cooperate to define a bounded region; and
the first and second translatable legs are configured to be positioned within the bounded region when the translatable securing member is at an uppermost position.

16. The ladder stabilization apparatus of claim 14 wherein the second translatable leg is rotatably attached to the sidewalls.

17. The ladder stabilization apparatus of claim 14 wherein:
the translatable securing member comprises a securing control device configured to interface with an outer surface of the first leg and, when so interfaced, displace the translate the translatable securing member away from the first leg and interface with the upper walls of the retaining structure;
the translatable securing member is secured in place and prevented from translating along the translation axis via the interfacing of the securing control device and the first leg and the interfacing of the translatable securing member and the upper walls; and
the securing control device is configured to de-interface with the outer surface of the first leg, thereby, permitting the translatable securing member to translate along the translation axis.

18. The ladder stabilization apparatus of claim 17 wherein:
the securing control device comprises a threaded member and a handle; and
the translatable securing member comprises a body member comprising a threaded hole, the threaded hole configured to cooperate with the threads of the threaded member.

19. The ladder stabilization apparatus of claim 14 further comprising a foot member attached to a lower surface of the second translatable leg.

20. A ladder comprising:
a plurality of legs;
a plurality of steps connected at each end to the plurality of legs;
a plurality of translatable securing members configured to translate along a translation axis of the translatable securing member and be removably secured at a position along the translation axis thereof relative to a leg of the plurality of legs;
a plurality of first translatable legs rotatably attached at a first end thereof to a translatable securing member of the plurality of translatable securing members and configured to rotate about a first rotation axis; and
a plurality of second translatable legs rotatably attached at a first end thereof to the a leg of the plurality of legs and configured to rotate about a second rotational axis and rotatably attached at a second end thereof to a second end of a first translatable leg of the plurality of translatable legs and configured to rotate about a third rotational axis;
wherein translation of the translatable securing members along the translation axes thereof causes rotation of the first translatable leg connected thereto about the first rotational axis thereof and rotation of the second translatable leg attached thereto about the second rotational axis thereof.
